(19) United States
(12) Patent Application Publication
(10) Pub. No.: US 2013/0212204 A1
(43) Pub. Date: Aug. 15, 2013

(54) METHOD AND SYSTEM FOR MONITORING AND LIMITING WIRELESS NETWORK ACCESS BASED UPON LOCATION PARAMETERS

(71) Applicant: Philip F. Kearney, III, San Jose, CA (US)

(72) Inventor: Philip F. Kearney, III, San Jose, CA (US)

(73) Assignee: QUALCOMM ATHEROS, INC., San Jose, CA (US)

(21) Appl. No.: 13/371,306

(22) Filed: Feb. 10, 2012

(51) Int. Cl. H04W 84/02; G06F 15/16; G06F 15/173

(52) U.S. Cl. 709/208; 709/225

(57) ABSTRACT

A method of limiting access to a wireless network is disclosed. The method includes broadcasting boundary coordinates associated with the wireless network. The broadcast coordinates are detected by a remote wireless device seeking access to the network. The remote wireless device determines whether it is within the broadcast boundary coordinates of the network.

### TECHNICAL FIELD

The present specification describes an apparatus and method that generally relates to controlling access to a network based on geo-limiting the coverage of the network. The apparatus and method may apply to any communication system and more specifically to a wireless LAN system.

### BACKGROUND

The IEEE 802.11 standard specifies that devices may initiate wireless communication based on an authentication and association process. This often involves broadcasting a beacon with a first wireless device. A second wireless device in range of the beacon may wirelessly detect and respond to the beacon. Provided that pre-specified authentication and association requirements are satisfied, the first device and second device may wirelessly connect. In this environment, the network of the first device is defined as a coverage area based on the RF characteristics of the first device radio signal and the transceiver of the second device.

Although the basic authentication and association process outlined above works well for its intended applications, the reliance on RF characteristics to establish the network boundary may prove problematic in certain circumstances. For example, in a building environment where the RF characteristics may far exceed the building walls, a device located outside of the walls may be able to gain access to a conventional wireless network unless other security safeguards are set in place. Thus, the need exists to provide new capabilities of establishing wireless network boundaries.

### BRIEF DESCRIPTION OF THE DRAWINGS

FIG. 1 illustrates a conventional wireless network including two wireless devices and their initial communication frames.

FIGS. 2A and 2B illustrate embodiments of geo-networks and their associated coverage areas.

FIG. 3 illustrates access to a wireless network that is geo-limited according to the present specification.

FIGS. 4A, 4B, 4C, 4D and 4E are flowcharts illustrating various methods for controlling access to a network based on geo-limiting according to the disclosure herein.

The components in the figures are not necessarily to scale, emphasis instead being placed upon illustrating the principles of the present specification. In the figures, like reference numerals designate corresponding parts throughout the different views.

### DETAILED DESCRIPTION

The present specification discloses a method and associated apparatus for controlling access to a network based on “geo-limiting”. In one embodiment, the method includes broadcasting boundary coordinates associated with the wireless network. The broadcast coordinates are detected with a remote wireless device seeking access to the network. The remote wireless device determines whether it is within the broadcast boundary coordinates of the network.

In a further embodiment, a method of limiting access to a master-slave wireless network may include defining a geographic boundary associated with the master-slave wireless network. A request may be sent by a remote wireless device to access the master-slave wireless network. A determination may be made as to whether the remote device lies within the boundary. Access to the wireless network may then selectively granted to the remote wireless device based upon the boundary determination.

In yet another embodiment, a wireless network is disclosed that includes at least one network access point for communicating with a remote wireless device. The access point has a beacon generator to transmit a beacon that includes coordinate information defining a geographic boundary. The access point selectively grants the remote wireless device access to the wireless network based on the coordinate information.

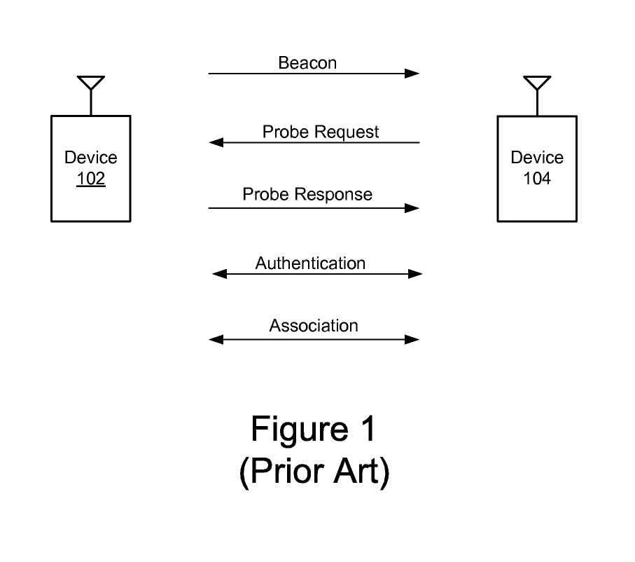

FIG. 1 illustrates a generic conventional wireless local area network (WLAN) that employs a first device 102, such as an access point (AP), and a second device 104, such as a station (STA). An AP may be a device that allows wireless devices to connect to a wired network using the IEEE 802.11 standards or other suitable wireless standards. APs may comprise computer components that may include microprocessors or microcontrollers. An AP may also include a router, an Ethernet switch and/or a broadband modem. A station may be a device capable of communicating wirelessly with the AP and may be, for example, a client station, a wireless stations, a mobile station, a mobile device, or a network interface card (NIC). In this specification, wireless station, client station, mobile station, mobile device and NIC may be used interchangeability. A station may comprise computer components such as microprocessors or microcontrollers. Further, as more fully explained below, the concepts presented herein may also be extended to Wi-Fi peer-to-peer networks.

The communication process between the two devices may be initiated by transmitting beacons or probe requests from one device to the other device. Once communication is achieved, the devices proceed to initiate a security process comprising authentication and encryption methods.

Once authentication and encryption have been completed, client stations may associate (register) with an AP to gain full access to the network. Association allows the AP to record the mobile devices so that frames may be properly delivered. Connection to the network may be in a point to multi-point environment such as an infrastructure basic service set (BSS) or in a point to point environment such as an independent BSS (peer-to-peer network). The communication protocols, including the authentication/association procedures of the IEEE 802.11 standards may apply to the methods of the present specification.

Generally, for WLAN systems in an infrastructure BSS, there is a three step association process. First, after the wireless station authenticates to an AP, the wireless station sends an Association Request. Next, the AP processes the Association Request. AP vendors may have different implementations for deciding whether or not a client request may be allowed. The AP grants the association and responds with a status code of 0 (successful) and an Association ID (AID). The latter is used to identify the station for delivery of buffered frames when power-saving is enabled for the station. Failed Association Requests may include a status code and the procedure ends. Finally, the access point forwards frames to/from the wireless station.

FIG. 1 illustrates the communication process previously described as applied to a BSS of a WLAN system. As illustrated in FIG. 1, the first device 102 and the second device 104 may exchange beacons and probe request/responses. In one embodiment, the first device 102 is an access point and transmits beacons. The second device 104 operates as a client device within radio range of the beacons and receives the beacon signals accordingly. The second device 104 responds and transmits a probe request that is received by the first device 102. Following this process, the first device 102 transmits a probe response to the second device 104. The two devices then proceed with the authentication and encryption process. Once authenticated, the devices 102 and 104 enter the association process. Once the association process is completed, the devices 102 and 104 are fully connected and the second device 104 will have full access to the network of the first device 102.

In WLAN systems, devices may locate each other by one of two scanning methods. In one method, client stations listen to beacons from each AP to gather information about nearby APs. Based on this information, the client station may selectively proceed with an association process. In another method, client stations actively scan by sending probe request frames to the broadcast address of an access point. APs may be required to respond to probe request frames (broadcast) with a probe response frame (unicast) which essentially contains the same information as a beacon.

In the prior discussion for FIG. 1, it was assumed that the first device 102 operates as an AP and that the second device 104 operates as a client station. In another embodiment, device 102 and device 104 may both be client stations. In such an embodiment, the devices may operate as an independent basic service set (IBSS). For example, device 104 may transmit a probe request to device 102. Device 102 may respond to the request (probe response) and a similar authentication/encryption and association process may follow such that the first device 102 and the second device 104 become fully connected.

The paragraphs above describe some common methods of controlling access to a wireless network via an authentication/association process. As previously noted, the communication protocols of the IEEE 802.11 standards describe specific methods that may apply to WLAN systems. Other authentication/association methods are possible. The methods of the present specification will now be described that incorporate geo-limiting parameters to control access to the network. The devices may follow the procedures of the IEEE 802.11 standards to obtain authentication/association incorporating geo-limiting requirements.

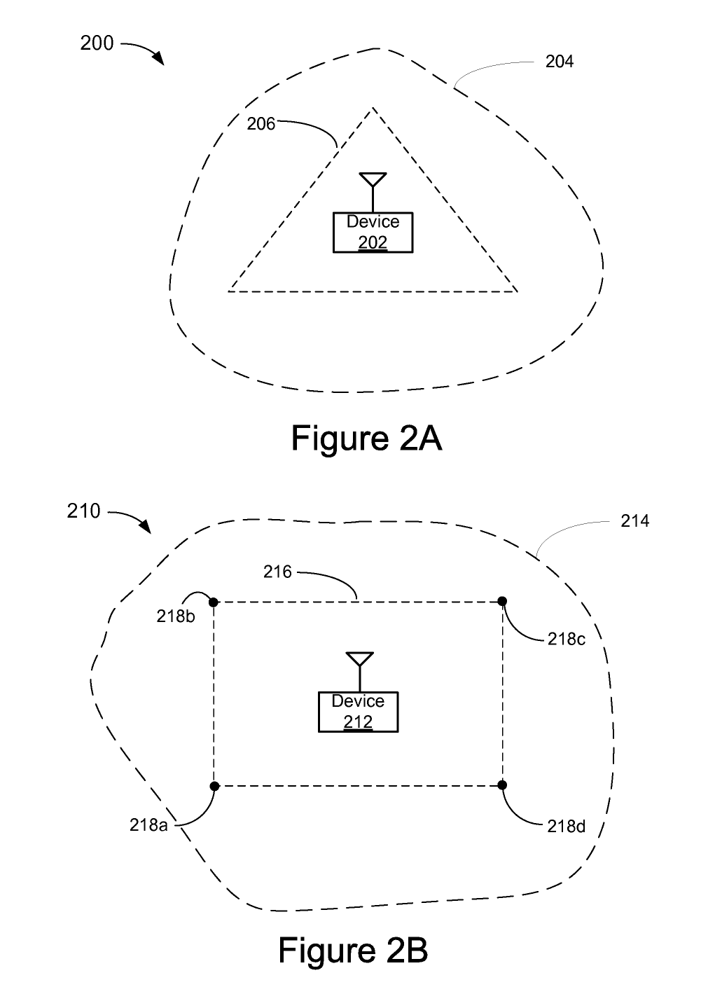

FIGS. 2A and 2B illustrate embodiments of geo-networks and their associated coverage areas according to the present specification. “Geo-network” refers to a network that is geo-limited; that is the network is defined by a geographic area that is within the RF coverage area of a device, such as an access point. An access point may control access to its network by requiring that the station be located within its geo-network.

A first network, generally designated 200 in FIG. 2A, employs a device 202 that transmits an RF signal within an RF coverage area 204. Located inside the RF coverage area is a defined geographic area that is bounded by a triangular periphery 206. Device 202 controls its network access to the triangular boundary, which defines a geo-network.

Similarly, FIG. 2B illustrates a network, generally designated 210, that includes a device 212 to transmit an RF signal within an RF coverage area 214. Located inside the RF coverage area is a rectangular boundary 216 defined by coordinate points 218a, 218b, 218c and 218d. Geo-limiting networks may be of any shape and may also be defined in a three dimensional space. A possible application may be a public hot spot.

For example, if it determined that the STA is inside the geographic bounds of a geo-network, then the STA may be allowed to associate with the AP. If not, the association request may be denied. This behavior may be enforced each time a STA tries to initially join a network or roams from one AP to another AP on the network. Hence, the method is implemented each time the STA associates or re-associates with the AP.

The Wi-Fi Network “Geo-Limiting” Service

Passive Geo-Limiting

As part of the beacon and/or probe response for each AP which supports “geo-limiting”, there is a “geo-limit” information element in the beacon/probe response. This information element contains data specifying the geographical bounds of the geo-network in terms of earth coordinates or other positional information. Any device (e.g. STA) receiving such beacon/probe responses that supports “geo-limiting”, may review these geographical bounds, determines its own point location coordinates, and further determines if the device is inside those bounds through a straightforward comparison. If not inside those bounds, the device may either not add that network to the list of available networks for the user to choose to join or else possibly alert the user that the device may not be able to join the geo network because the device is outside the geographical bounds of the network. This method is called “passive geo-limiting” because it is possible for the STA to join the network even though it is outside the bounds of the network and because the STA is responsible for determining its location and whether or not it is outside the established bounds of the network.

Active Geo-Limiting

A Wi-Fi network may support “active geo-limiting”. In this case, each time a STA tries to associate to the given geo-network, the AP to which the STA is attempting to associate solicits the STA for its geographical point location information. The AP then may review the point location information and determine whether or not the STA is inside the geographical bounds of the network. If the STA is inside the geographical bounds of the network, then the STA is allowed to associate. If not, the association request is denied.

Verified Geo-Limiting

To enhance an administrator's ability to geo-limit the network even further, there may be an option for “verified active geo-limiting” or simply “verified geo-limiting”. A Wi-Fi network that supports “verified geo-limiting” may perform the tasks described above and may go one step further to ensure that each STA requesting association to the network is accurately reporting its geographical location as part of the active geo-limiting process. This may be referred to as position verification. In this case, when the requesting STA reports its geographic location to the AP, that AP initiates position verification for that device using the other APs in the area that may “see” the requesting STA. An example of position verification may use an active triangulation process (e.g. Time Domain Of Arrival—TDOA), the APs may estimate the geographic location of the requesting STA relative to the AP to determine whether or not the STA is inside the geographical bounds of the geo-network. The triangulation process may require three or more nearby devices or access points in order to determine the location of the STA. Additionally, other location technologies may be used to determine the location of the STA.

Periodic Verified Geo-Limiting

If a network supports “verified geo-limiting” for each STA that joins a given geo-network, the APs of that network may also be configured to periodically verify the position of associated STAs currently connected to the given AP that supports “verified geo-limiting”. The administrator may define a time period between checks. The AP may store the time each STA was last verified. When an elapsed time reaches a pre-defined time limit (time period), that STA is re-verified as being inside the geographical bounds of the network using the same verified geo-limiting technique described above for STAs. If the STA is determined to no longer be inside the geographical bounds of the network, it may be immediately disassociated from the network by the AP.

In general, applications for the embodiments described herein include home, enterprise and public access environments. These systems may be developed with a continuum of procedures from a lower level of intrusiveness (such as passive geo-limiting) to a higher level of intrusiveness (such as verified geo-limiting). Some specific applications may include robotic systems for manufacturing, prisoner tracking, and asset tracking.

One may identify service and security benefits of geo-limiting for enterprise Wi-Fi networks and their administrators. The geo-limits of an enterprise network may be based upon specified internal dimensions of a building or an interior of a set of buildings. For multi-floor buildings exhibiting a three dimensional space, the geo-limit of a specific network may be confined to devices currently located on a specific floor of the building. Also, Wi-Fi network access on airplanes may employ three dimensional space geo-limiting to only allow devices to connect to the in-flight Wi-Fi service when the plane is at its cruising altitude and stop the service as the plane ascends and descends during takeoff and landing. For robots on assembly lines, the same robot may automatically know when to perform different specific tasks based upon the location inside a factory to which it was moved. By moving the robot, it knows to connect to a different geo-limited network where it receives its instructions for the specific task. Mobile devices may join different geo-limited networks automatically in public spaces. There are other applications that may utilize these concepts.

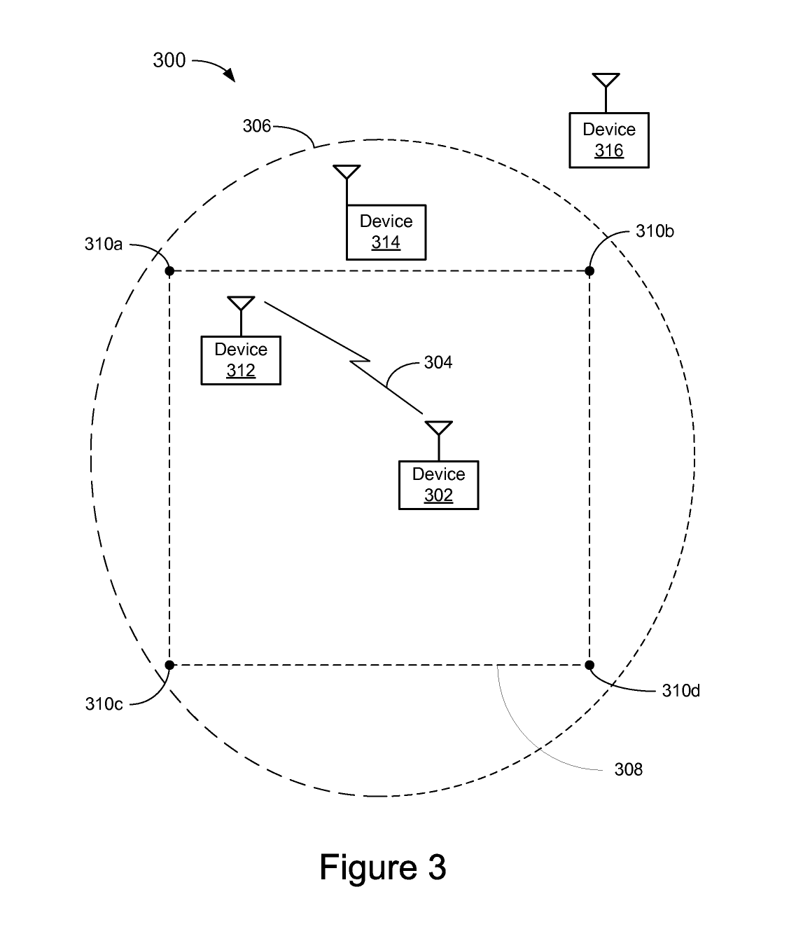

FIG. 3 illustrates several aspects of a network, generally designated 300, operating in a geo-limited mode. A first device 302, such as an access device, transmits an RF signal such as a beacon 304 within an RF coverage area 306. Located inside the RF coverage area is a geo-network boundary 308 defined by coordinates 310a, 310b, 310c and 310d. The coordinates 310 define a square-shaped geo-limited coverage area. The access device 302 controls network access to the geo-limited area 308. For example, a client device 312 may be located within the boundary of the geo-network 308. Thus, the client device 312 may connect (associate) with the access device 302. Alternatively, a second client device 314 may not be located within the geo-network 308, although it is located within the RF coverage area 306. Thus, the second client device 314 may not associate with the access device 302. Further, another client device 316 may be located outside the RF coverage area 306. Consequently, the client device 316 will not receive the beacon signal from the first device 302 and no further action may occur.

An example consistent with the embodiment described above is a wireless stereo system operated in a geo-limited area. The access device 302 represents a wireless stereo receiver located in an apartment having walls that define a space corresponding to the geo-network 308. Client device 312 represents a wireless speaker. The wireless stereo receiver 302 may wirelessly connect to the wireless speaker 312 to establish a peer-to-peer network. A neighboring apartment may also have a wireless speaker (represented by device 314). Since this wireless speaker is located outside the geo-network 308, the wireless stereo receiver may not connect with a neighboring wireless speaker 314.

As noted previously, a geo-network may be a three dimensional space. In this case, a second device may employ pressure sensors responsive to varying heights in order to determine if it is within the three dimensional space of the geo-network. Alternatively, the second device may determine if it is within the three dimensional space of the geo-network based on high-resolution GPS coordinates capable of detecting changes in altitude. Further, x, y, and z coordinates may be determined using four or more APs (such as on multiple floors of a building with known x, y, and z coordinates.

With geo-limits, the operation of a device may be determined or influenced by its current location. If a device has knowledge of its current location and has criteria for operation within a certain geo-network, the device may operate based on is current location. For example, a device in an airplane may shut-off when it achieves a certain altitude. Or a device in the geo-network of a library may shut-off when it enters the library. With such features, the device may reduce the amount of scanning with an associated reduction in power consumption.

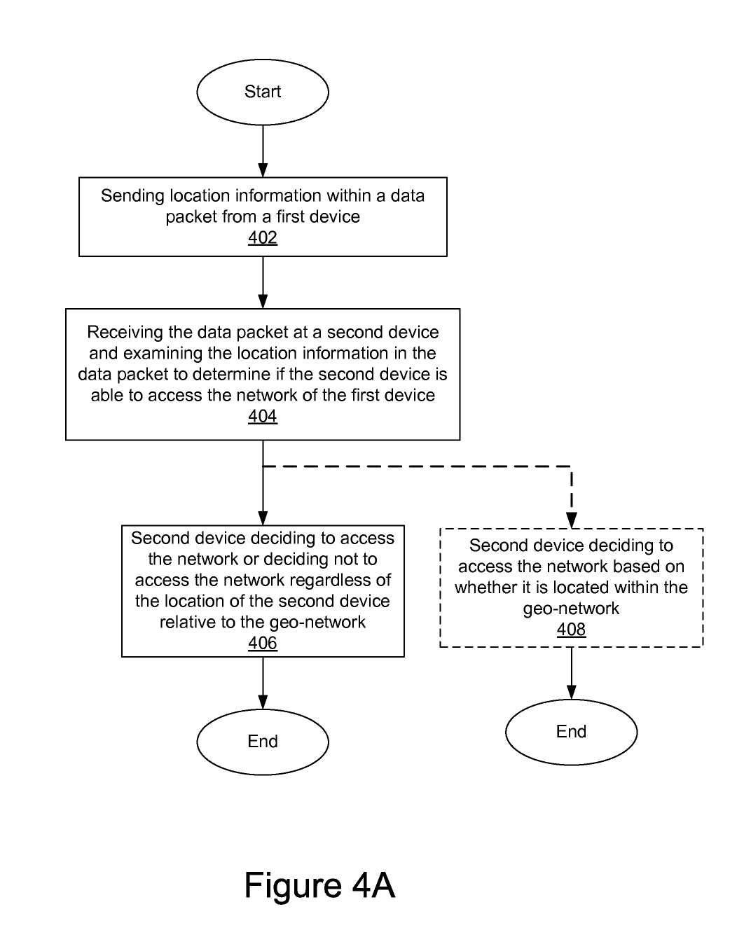

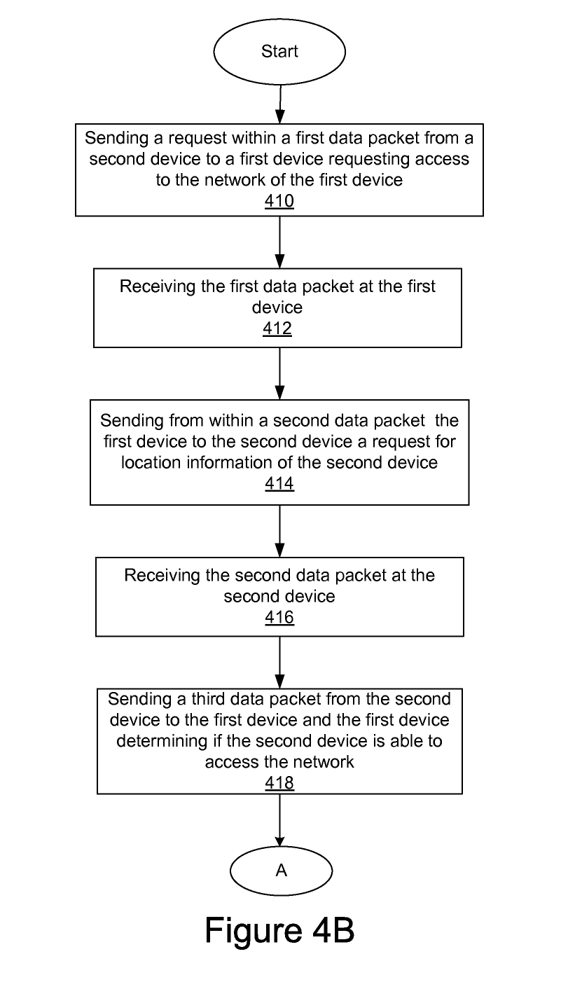

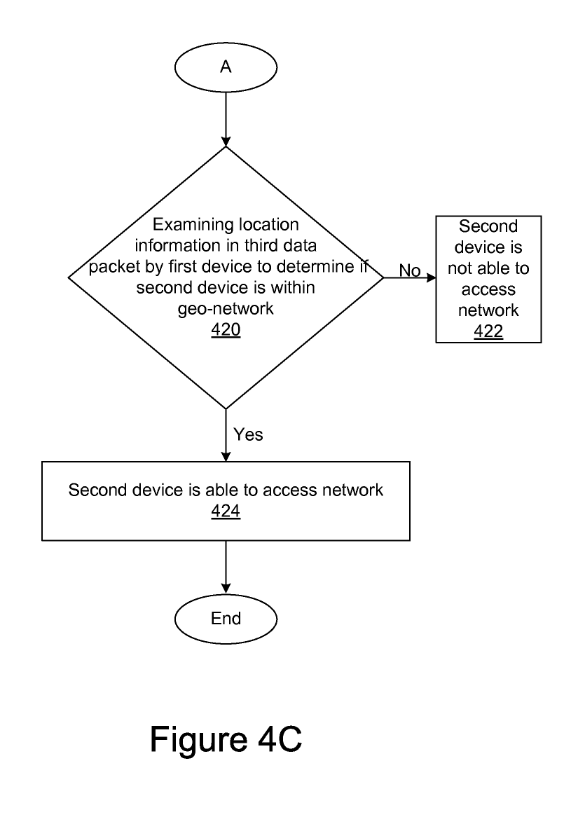

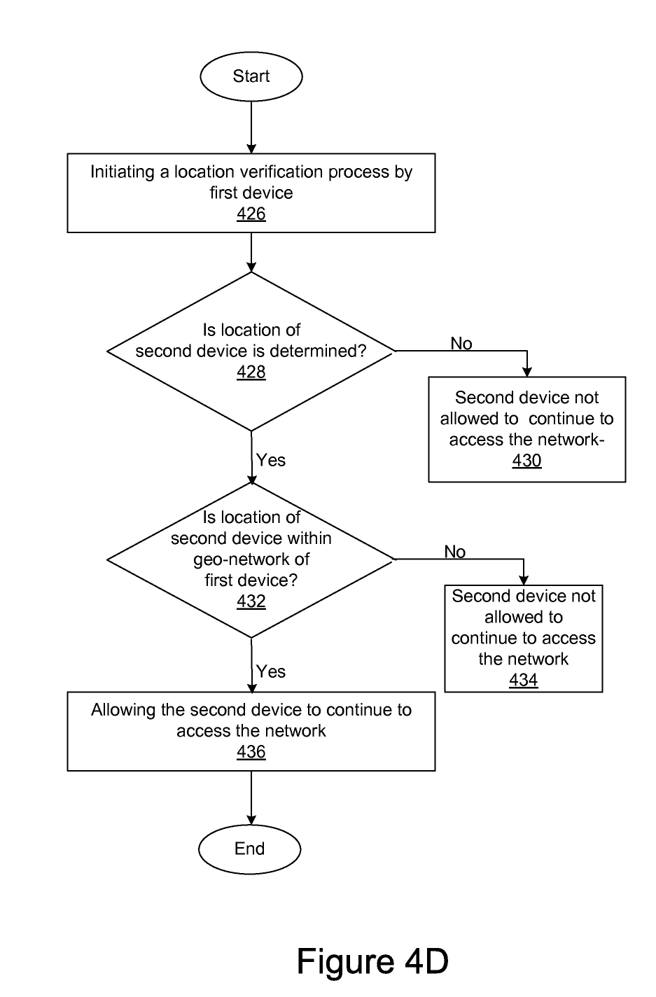

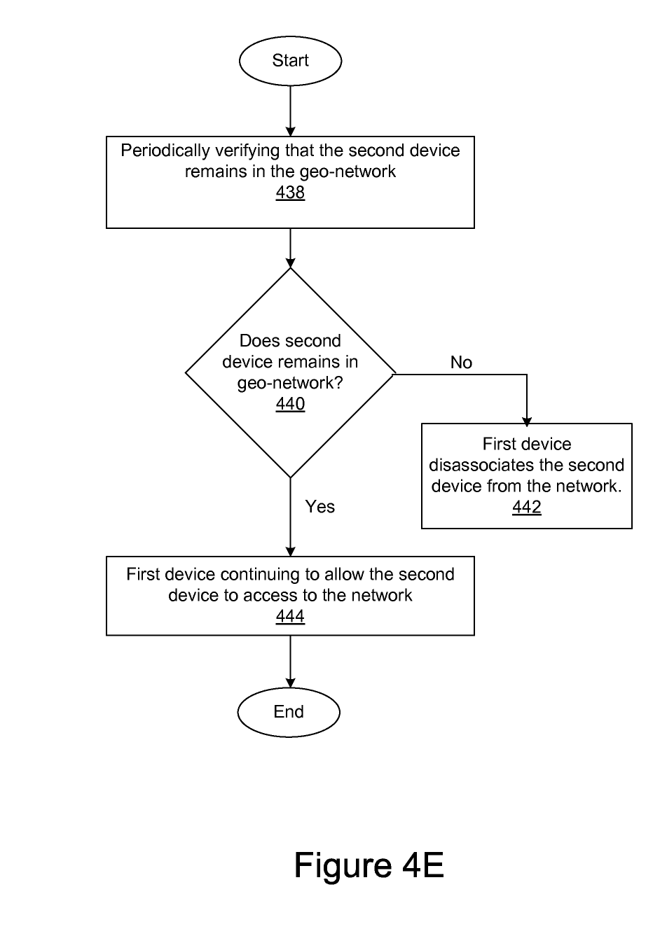

FIGS. 4A, 4B, 4C, 4D and 4E are flowcharts illustrating various methods for controlling access to a network based on geo-limiting according to the present specification. FIG. 4A illustrates steps in a passive geo-limiting method that begins by sending location information within a data packet from a first device, at step 402. The data packet is received, at step 404, at a second device that examines the location information in the data packet to determine if it is able to access the network of the first device. The second device may then decide to access the network or decide not to access the network regardless of the location of the second device relative to the geo-network, at step 406. Alternatively, at step 408, the second device may decide to access the network based on whether it is located within the geo-network.

FIGS. 4B and 4C illustrate steps defining a method similar to that shown in FIG. 4A, but involving active geo-limiting. At step 410, a request is sent within a first data packet from a second device to a first device requesting access to the network of the first device. The first data packet is received at the first device, at step 412. At step 414, a request for location information of the second device is sent from within a second data packet of the first device to the second device. The second device receives the second data packet, at step 416, at the second device. At step 418, a third data packet is sent from the second device to the first device and the first device determines if the second device is able to access the network. A determination is then made, at step 420, that involves examining location information in a third data packet by the first device to determine if the second device is within the geo-network. If the second device is not within the geo-network, the second device is not able to access the network, at step 422. If the second device is within the geo-network, at step 424, the second device is able to access the network.

FIG. 4D illustrates steps relating to a method of verified geo-limiting that involves first initiating a location verification process by a first device, at step 426. A determination is then made, at step 428, as to the location of the second device by the first device. If the location is not determined, the second device is not allowed to continue to access the network, at step 430. If the location of the second device is determined, at step 432, a further determination is made as to whether the second device is within the geo-network of the first device. If the second device is not within the geo-network of the first device, then the second device is not allowed to access the network, at step 434. If the second device is within the geo-network of the first device, then the second device is allowed to access the network, at step 436.

FIG. 4E illustrates method steps involving a periodic verified geo-limiting method. The method begins by periodically verifying that the second device remains in the geo-network, at step 438. A determination is then made, at step 440, as to whether the second device remains in the geo-network. If the second device does not remain in the geo-network, then the first device disassociates the second device from the network, at step 442. If the second device remains in the geo-network, at step 444, the first device continues to allow the second device to access to the network.

While various embodiments of the Specification have been described, it will be apparent to those of ordinary skill in the art that many more embodiments and implementations are possible that are within the scope of this Specification. For example, any combination of any of the systems or methods described in this disclosure is possible.

1. A method of limiting access to a wireless network, the method comprising:
broadcasting a beacon that includes embedded boundary coordinates associated with the wireless network;
detecting the beacon with a remote wireless device seeking access to the wireless network; and
determining, by the remote wireless device, whether the remote wireless device is within the boundary coordinates.

2-3. (canceled)

4. The method of claim 1, wherein the determining comprises:
establishing a relative location with respect to the boundary coordinates.

5. The method of claim 1, further comprising:
accessing the wireless network based on whether the remote wireless device is within the boundary coordinates.

6. The method of claim 1, wherein:
the broadcasting is carried out by an access point that controls the wireless network as a master device; and
the remote wireless device operates as a slave device responsive to the master device.

7. The method of claim 1, wherein the beacon is embedded with three-dimensional boundary coordinates.

8. A method of limiting access to a master-slave wireless network, the method comprising:
defining a geographic boundary associated with the master-slave wireless network;
sending a beacon embedded with the geographic boundary, the beacon being detectable by a remote wireless device seeking to access the master-slave wireless network;
determining whether the remote wireless device lies within the geographic boundary; and
granting access to the remote wireless device based upon the geographic boundary determination.

9. The method of claim 8, wherein the defining comprises:
defining a three-dimensional geographic boundary associated with the master-slave wireless network.

10. The method of claim 8, wherein the determining is carried out by a master device coupled to the master-slave wireless network.

11. The method of claim 8, wherein the determining is carried out by evaluating earth coordinate information.

12. The method of claim 8, wherein the determining involves evaluating a relative position between the remote wireless device and the geographic boundary.

13. The method of claim 8, wherein the determining comprises evaluating time domain of arrival information from a plurality of devices coupled to the master-slave wireless network with respect to the remote wireless device.

14. A wireless master-slave network comprising:
at least one network access point for communicating with a remote wireless device, the access point having a beacon generator to transmit a beacon, the beacon including coordinate information defining a geographic boundary of the wireless master-slave network, the access point being configured to selectively grant the remote wireless device access to the wireless master-slave network based on the coordinate information.

15. The wireless master-slave network of claim 14, further comprising:
a plurality of nodes having directional detectors, the directional detectors cooperating to determine a relative position of the remote wireless device based on time domain of arrival information.

16. A wireless master-slave network configured to:
broadcast a beacon that includes embedded boundary coordinates associated with the wireless master-slave network;
detect the beacon with a remote wireless device seeking access to the wireless master-slave network; and
determine, by the remote wireless device, whether the remote wireless device is within the boundary coordinates.

17. A network access point, comprising:
a beacon generator to transmit a beacon, wherein the beacon includes embedded coordinate information defining a geographic boundary of an associated wireless network, wherein the network access point is configured to:
receive positional information from a remote wireless device;
determine whether the remote wireless device lies within the geographic boundary based, at least in part, on the received positional information; and
selectively grant the remote wireless device access to the wireless network in response to the determining.
